(19) United States
(12) Patent Application Publication
(10) Pub. No.: US 2004/0225086 A1
(43) Pub. Date: Nov. 11, 2004

(54) Method for polymerising vinyl monomers and/or oligomers comprising at least one vinyl radical

(76) Inventor: Jean-Claude Lapairy, Beauvais (FR)

Correspondence Address: William Anthony Drucker, Suite 800, 1901 L Street N W, Washington, DC, 20036-3506, US

(21) Appl. No.: 10/484,252

(22) PCT Filed: Jul. 17, 2002
(86) PCT No.: PCT/FR02/02517

(30) Foreign Application Priority Data
Jul. 17, 2001 (FR) 01/09636

(51) Int. Cl. C08F 2/00

(52) U.S. Cl. 526/72; 526/319

(57) ABSTRACT

The invention concerns a method for polymerising vinyl monomers and/or oligomers comprising at least a vinyl radical, which consists in mixing the vinyl monomer or the oligomer comprising at least a vinyl radical with: at least dioxygen supplying agent, at least a aldehyde representing for example between 1% and 15% of the weight of the mixture, at least an accelerator which may for example of consist in a metallic salt.

### BACKGROUND OF THE INVENTION

1. Field of the Invention

The present invention involves a method for polymerising vinyl monomers and/or oligomers comprising at least one vinyl radical. It also involves the catalyst used in this method as well as the products specifically obtained by said method, that is, but not exclusively, products belonging to the following families:

non loaded products: translucent varnishes, translucent resins that may eventually be used in the impregnation of fibres, translucent “gel coats”,

pigmented products: paints, opaque resins, opaque “gel coats”,

products incorporating loads appropriate for the desired results, in particular:

fire resistance: flame resistant products including fire resistant materials such as aluminium tri-hydrate, standard or expansible mica, antimony tri or pentoxide, . . .

hardness: products including hard materials such as corunduym, silicon carbide, synthetic diamond, . . .

transparency: transparent or translucent products including quartz, pure silica, . . .

cost: products with a load consisting of inexpensive products such as carbonates, silica, etc. (for example, for the production of floor coverings),

the ability to be shaped.

In the rest of this document, it should be noted that the term vinyl in particular covers the terms acrylic and methacrylic.

2. Description of the Prior Art

In general, a great many types of paints or varnishes are known to be commercially available such as, for example, glyptal resin lacquers, acrylic and vinyl paints. Nevertheless, except for acrylic or vinyl water paints that have a poor chemical stability, there are no acrylic or vinyl paints that can be cross-linked by polymerisation. This is mainly due to the fact that the oxygen in the surrounding air inhibits polymerisation.

Solutions are available using photo initiators to polymerise this type of paint with UV. These products are very expensive. The installations are complicated, expensive and require complex protection for the personnel. The shape and size of the parts to paint are limited as is the thickness of the coat of paint as soon as there are opaque pigments or loads.

However, the use of cross-linked acrylic paints or varnishes is desirable in a great many applications due to the advantageous properties.

As regards mouldable resins such as, for example, phenyl, polyester, epoxy, acrylic, polyurethane resins, MODAR® by Ashland (oligomer with a double bond in solution in methyl methacrylate that acts with a catalyst for polymerisation), these resins have the same disadvantages as those mentioned above. Inside the moulds, the moulding surfaces always contain air bubbles that locally produce poor polymerisation. In addition, the polymerisation of large parts by UV radiation is not suitable due to the thickness of the parts, given that the UV rays are highly attenuated at the surface and do not penetrate to the core of the parts.

Another disadvantage with most resins is that below 100° C., the polymerisation requires the use of a very powerful catalyst, usually made of benzyol peroxide (usually in powder form) and an extremely toxic amine accelerator that produces a coloration of the finished product. This evolving coloration makes it difficult, or even impossible, to obtain the desired colour, in particular a light colour or white for a paint or a “gel coat”.

To solve the problem of the inhibition of the catalyst by oxygen during polymerisation, we recommended incorporating paraffin in the monomer/catalyst mixture so as to create an oxygen-impermeable screen at the surface of the mixture. This solution provides good polymerisation at the surface of the resin but nevertheless has the disadvantage that it provides parts with a dull, non glossy surface that has to be re-polished. In addition, the paraffin located at the surface hinders the subsequent hold of any product such as glue or a stratification resin.

A method (“Santolink”® resin by MONSANTO) was also recommended. It consists of transforming a specific monomer into hydroperoxide for the polymerisation of monomers. Nevertheless, this solution did not have the anticipated success due to its low reactivity on the one hand and, on the other hand, due to the production of acroleine during polymerisation, a product that is well known for its high toxicity.

Patent DE 44 01 387 describes a method for the hot polymerisation of acrylic polymers in emulsion that uses aldehydes as catalysts. The disadvantage involved in this solution is due to the fact that:

it uses a hot emulsion,

it does not involve an accelerator,

it is highly sensitive to dioxygen. In the presence of dioxygen (for example, air), the aldehyde oxidises by forming an acid.

### OBJECT OF THE INVENTION

The invention starts with the observation that it is possible to create vinyl monomers and oligomers comprising vinyl radicals that present especially desirable properties (no odour, high vaporisation point eliminating the risk of inflammation and deflagration, no toxicity, possibility of working in normal atmospheric conditions, etc.).

Now, until now, these monomers or oligomers were not used in the previously mentioned applications since they could not be polymerised in satisfactory conditions. Radical polymerisation that uses a peroxide and possibly an accelerator such as, for example, amines, does not work very well. The radicals that act with the double bonds C═C in order to inhibit their polymerisation and thereby trigger the growth of the polymer chain do not have sufficient activation energy. In addition, certain types of compounds provide a suitable polymerisation reaction but with a final product that is tainted with defects such as, in particular, yellowing or inadmissible toxicity.

In addition, the radicals formed during the polymerisation reaction are known to be very sensitive to the dioxygen mainly coming from the surrounding air. In fact, dioxygen reacts with the active radical centres, coming from peroxides and/or forming chains of polymers, and thereby inhibits the polymerisation of vinyls and acrylics.

The methyl ethyl ketone peroxide PMEC often used, in particular for the polymerisation of styrene, does not have sufficient activation energy to initiate the polymerisation of acrylic or vinyl monomers. In addition, one of the decomposition reactions of this peroxide provides dioxygen that, added to the dioxygen in the air, helps inhibit the polymerisation reaction, including at the core of the polymer, the atmospheric dioxygen inhibiting the acrylic or vinyl polymerisation more specifically at the surface.

### SUMMARY OF THE INVENTION

Therefore, the invention especially aims at eliminating these disadvantages so as to be able to benefit from the advantages of vinyl monomers and oligomers while overcoming the problems resulting from their polymerisation.

For this purpose, it proposes a method of polymerisation consisting of mixing the vinyl monomer or oligomer with at least on vinyl radical with:

at least one dioxygen supplying agent,

at least one aldehyde representing, for example, between 0.1% and 15% of the weight of the mixture,

at least one accelerator.

One specific feature of the method according to the invention is the use of dioxygen in the polymerisation method, contrary to the preconception of the man of the art who until now considered it as a polymerisation reaction poison. This use presents the advantage of being free of the problem resulting from the presence of dioxygen in the immediate environment of the reaction (for example, at the surface of the moulds).

A second advantage of this method lies in the polymerisation kinetics that enables an extension of the phase where the polymer has the texture of a gel.

### DESCRIPTION OF THE PREFERRED EMBODIMENTS

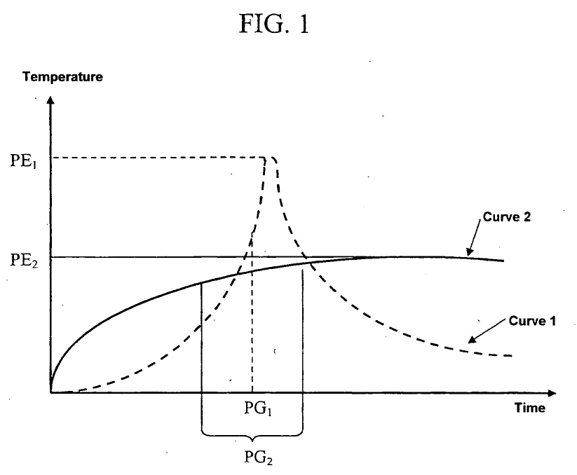

In the classic methods, it is known that polymerisations using, for example, an amine and benzoyl peroxide have a high exothermic peak, PE₁, as shown in curve 1 of FIG. 1 indicating the temperature of the reaction as a function of time and a very short gel phase, PG₁.

This type of reaction has a very high exothermic peak exceeding the boiling point of monomers, thereby presenting a risk of the formation of bubbles in the mass of the polymer. These sudden variations in temperature also provoke internal stress.

In addition, in this case, the polymer only has the texture of a gel for a very short period.

The method according to the invention spreads out of the exothermic peak, PE₂, as shown in curve 2 of FIG. 1, thereby avoiding the air bubbles and stress.

By playing with the aldehydes, it also prolongs the duration of gel phase PG₂, enabling, for example, the deflashing of the parts while they are malleable.

The aldehyde used in accordance with the method according to the invention complies with the following general formula:

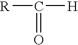

formula in which radical R is a compound comprising at least one carbon atom.

The invention uses the known method that consists in that the more radical R is a donor of electrons, the more the formation of a hydroperoxide group is favoured in situ, then the presence of an accelerator creates radicals provoking the beginning of polymerisation.

By way of example, the aldehyde used may consist of one of the following aldehydes or a combination of at least two of these aldehydes:

hydratrophic aldehyde (good reactivity)

phenylacetic aldehyde (medium reactivity)

3,7-dimethyl-2,6-octadienal aldehyde (more efficacy with air depending on the monomers used)

3-methoxy-4-hydroxy benzaldehyde

3,4-dimethoxy benzaldehyde

hydroxy-2-benzaldehyde

hydratrophic aldehyde

4-hydroxy-3,5-dimethoxy benzaldehyde (syringa aldehyde)

decenal-4-trans

alpha hexylcinnamic aldehyde

undecylic aldehyde (C11 aldehyde).

The agent supplying the dioxygen may comprise at least one of the catalysts listed below:

hydrogen peroxide H₂O₂

a hydroperoxide (R—O—O—H: acid esters of hydrogen peroxide)

PMEC (methyl ethyl ketone peroxide)

PAA (acetyl acetone peroxide)

cyclohexanone peroxide

tert-butyl peroxybenzoate

tert-butyl peroxy isopropyl carbonate

2,5-bis(2-ethylhexanoyl-peroxy)-2,5-dimethylhexane

tert-butyl peroxy-2-ethylhexanoate

tert-butyl peroxy-3,5,5-trimethylhexanoate

1,1-bis(tert-butylperoxy)-3,3,5-trimethylcyclohexane

dicumyl peroxide

bis(4-tert-butylcyclohexyl) peroxydicarbonate

ketone peroxide

perester

As mentioned above, the accelerator used may consist of any product that can break down a peroxide. For example, it may comprise one or several of the following compounds:

a metal salt such as vanadium salt, a cobalt salt,

a potassium salt,

an amine.

This accelerator may represent, for example, 0.1% to 1.0% of the weight of the mixture.

In fact, the polymerisation method according to the method in the invention is a method comprising four phases, that is:

A first phase during which the accelerator reacts with the oxygen generating agent to produce dioxygen O₂.

A second phase of aldehyde oxidation due to the oxygen given off by the oxygen generating agent and the oxygen possibly dissolved or present at the surface according to the following diagram:

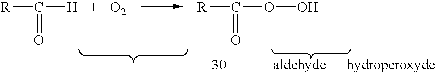

without the presence of accelerators (metal or other salts), this hydroperoxide will not be broken down into radicals but will undergo a second phase of oxidation providing an acid.

A third phase in which the hydroperoxide obtained after the oxidation phase reacts with the rest of the accelerator to produce a cation RCO₂⁺ according to the following diagram:

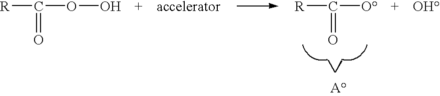

The cation RCO₂⁺ indicated by letter A° hereafter has sufficient activation energy to initiate the polymerisation of the vinyl monomer or oligomer.

A fourth polymerisation phase of the vinyl monomer (or oligomer) according to the following diagram:

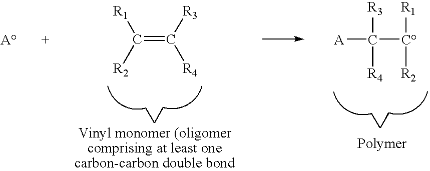

Advantageously, all of the compounds used in the method according to the invention may come in liquid phase.

These products may be sold in bi-component form, one of these components comprising an oxygen generating agent, an aldehyde and a possible inhibitor, while the other may comprise the monomer (or oligomer) and an accelerator.

Examples of the use of the method according to the invention will be described below, by way of non limiting examples.

### EXAMPLE 1

### Varnish

Triacrylate aliphatic urethane 32%

Triacrylate hexanediol 23%

Triacrylate acid adhesion promotor 7%

6% cobalt octoate accelerator type NL51P by AKZO 0.3%

50% methyl ethyl ketone peroxide type Butanox LPT by AKZO 1%

3,7-dimethyl-2,6-octadienal aldehyde 5%

Hydratrophic aldehyde 3.7%

Once the products are mixed, it is possible to apply the product thereby obtained with a brush or gun. Surface polymerisation is obtained with a shiny and non slimy film.

### EXAMPLE 2

### Varnish on Metal

Aliphatic urethane acrylate 17%

Diacrylate hexanediol 40%

Tetrafunctional epoxyacrylate 17%

Etoxylated triacrylate trimethylopropane 20%

6% cobalt octoate accelerator type NL51P by AKZO 0.3%

50% methyl ethyl ketone peroxide type Butanox LPT by AKZO 1%

3,7-diemthyl-2,6-octadienal aldehyde 2.5%

Phenacetic aldehyde 2.2%

Once the products are mixed, it is possible to apply the product thereby obtained with a brush or gun on a metal backing. Surface polymerisation is obtained with a shiny and non sticky film, adhering especially well to the metal.

### EXAMPLE 3

### White Chemically Resistant “Gel Coat”

Bisphenol A methacrylate 54%

Trimethacrylate trimethylolpropane 14%

Isodecyl acrylate 20%

Titanium dioxide 5%

Silica tixotropant agent type aerosol 200 by Degussa 0.3%

6% cobalt octoate accelerator type NL51P by AKZO 0.3%

50% methyl ethyl ketone peroxide type Butanox LPT by AKZO 1%

3,7-dimethyl-2,6-octadienal aldehyde 3%

Hydratrophic aldehyde 1%

Once the products are mixed, it is possible to apply the product thereby obtained with a brush or gun on a mould. Surface polymerisation is obtained with a shiny and non sticky film. It is then possible to apply a resin and reinforcement fibre composite that will perfectly adhere to this “gel coat”. After the polymerisation of this composite, a surface “gel coat” is obtained with a very good appearance, that is chemically resistant and is especially anti-graffiti.

### EXAMPLE 4

### Resin Concrete

Dimethacrylate butanediol 3%

Methacrylate methyl 14.4%

Powder polymethylmethacrylate 2%

Fontainebleau sand 75%

Silica tixotropant agent type aerosol 200 by Degussa 0.3%

6% cobalt octoate accelerator type NL51P by AKZO 0.3%

50% methyl ethyl ketone peroxide type Butanox LPT by AKZO 1%

3,7-dimethyl-2,6-octadienal aldehyde 3%

Hydratrophic aldehyde 1%

Once the products are mixed, a resin concrete is obtained that can be poured into a mould or spread out on an industrial floor. After polymerisation, a non sticky product is obtained at the surface with a very beautiful appearance.

In these four examples, the last three products, PMEC, 3,7-dimethyl-2,6-octadienal aldehyde and hydratrophic or phenacetic aldehyde may be pre-mixed with an inhibitor type TBC tertiobutylcatecol (between 0.01 and 1%) to forn a stable hardener that will be mixed with the previously indicated formulations.

1. Method for polymerising vinyl monomers and/or oligomers comprising at least one vinyl radical said method,
consisting of mixing said vinyl monomer or said oligomer with the following components:
at least one dioxygen providing agent,
at least one aldehyde,
at least one accelerator.

2. Method according to claim 1,
wherein said aldehyde represents between 0.1% and 15% of the weight of the mixture.

3. Method according to claim 1,
wherein said aldehyde complies with the following general formula: 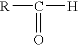
formula in which radical R is a compound comprising at least one carbon atom.

4. Method according to claim 1,
wherein said aldehyde consists of one of the following aldehydes or a combination of at least two of these aldehydes:
hydratrophic aldehyde
phenylacetic aldehyde
3,7-dimethyl-2,6-octadienal aldehyde
3-methoxy-4-hydroxy benzaldehyde
3-4-dimethoxy benzaldehyde
hydroxy-2-benzaldehyde
hydratrophic aldehyde
4-hydroxy-3,5-dimethoxy benzaldehyde (syringa aldehyde)
decenal-4-trans
alpha hexylcinnamic aldehyde
undecylic aldehyde (C11 aldehyde).

5. Method according to claim 1,
wherein the dioxygen providing agent consists of one of the catalysts found in the following list:
hydrogen peroxide H₂O₂
PMEC (methyl ethyl ketone peroxide)
PAA (acetyl acetone peroxide)
cyclohexanone peroxide
tert-butyl peroxybenzoate
tert-butyl peroxy isopropyl carbonate
2,5-bis(2-ethylhexanoyl-peroxy)-2,5-dimethylhexane
tert-butyl peroxy-2-ethylhexanoate
tert-butyl peroxy-3,5,5-trimethylhexanoate
1,1-bis(tert-butylperoxy)-3,3,5-trimethylcyclohexane
dicumyl peroxide
bis(4-tert-butylcyclohexyl) peroxydicarbonate
ketone peroxide
perester

6. Method according to claim 1,
wherein said accelerator consists of any product that can break down a peroxide.

7. Method according to claim 1,
wherein said accelerator comprises one or several of the following compounds:
a metal salt such as a vanadium salt, a cobalt salt,
a potassium salt,
an amine.

8. Method according to claim 1,
wherein said accelerator represents from 0.1% to 1% of the weight of the mixture.

9. Method according to claim 1 comprising four phases, that is:
A first phase during which the accelerator reacts with the oxygen generating agent to produce dioxygen O₂.
A second phase of aldehyde oxidation due to the oxygen given off by the oxygen generating agent and the oxygen possibly dissolved or present at the surface according to the following diagram: 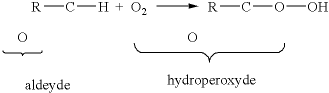
A third phase in which the hydroperoxide obtained after the oxidation phase reacts with the rest of the accelerator to produce a cation RCO₂⁺ according to the following diagram: 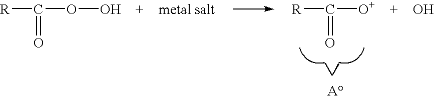
A fourth phase of polymerisation of the vinyl monomer (or oligomer) according to the following diagram:

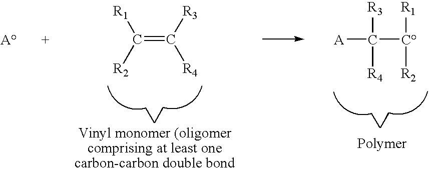

10. Method according to claim 1,
wherein said vinyl monomer or oligomer and said components are in liquid phase.

11. Method according to claim 1,
wherein said vinyl monomer or oligomer and said components are in bi-components form.

12. Method according to claim 10,
wherein one of the components comprises an oxygen generating agent, an aldehyde or a possible inhibitor while the other comprises the monomer and/or oligomer and an accelerator.

18. Method according claim 12 wherein the inhibitor is a tertiobutylcatecol TBC.

19. Product obtained by polymerizing a vinyl monomer or oligomer comprising at least one vinyl radical, by mixing said vinyl monomer or oligomer with the following components:
at least one dioxygen providing agent,
at least one aldehyde,
at least one accelerator
said product consisting of a varnish or a paint.

20. Product obtained by polymerizing a vinyl monomer or oligomer comprising at least one vinyl radical, by mixing said vinyl monomer or oligomer with the following components:
at least one dioxygen providing agent,
at least one aldehyde,
at least one accelerator
said product consisting of a “gel coat” or a “top coat”.

21. Product obtained by polymerizing a vinyl monomer or oligomer comprising at least one vinyl radical, by mixing said vinyl monomer or oligomer with the following components:
at least one dioxygen providing agent,
at least one aldehyde,
at least one accelerator
said product consisting of a resin to produce composite materials.

22. Product obtained by polymerizing a vinyl monomer or oligomer comprising at least one vinyl radical, by mixing said vinyl monomer or oligomer with the following components:
at least one dioxygen providing agent,
at least one aldehyde,
at least one accelerator
said product consisting of a resin concrete.
